(19) United States
(12) Patent Application Publication
(10) Pub. No.: US 2013/0037741 A1
(43) Pub. Date: Feb. 14, 2013

(54) HEAT TRANSFER MEDIUM BASED ON SULPHUR AND USE OF THE HEAT TRANSFER MEDIUM

(71) Applicants: Juergen Birnbaum, Nuernberg (DE); Peter Groeppel, Erlangen (DE); Matthias Uebler, Ursensollen (DE)

(72) Inventors: Juergen Birnbaum, Nuernberg (DE); Peter Groeppel, Erlangen (DE); Matthias Uebler, Ursensollen (DE)

(21) Appl. No.: 13/641,951

(22) PCT Filed: Apr. 18, 2011
(86) PCT No.: PCT/EP2011/056111

§ 371 Date: Oct. 18, 2012

(30) Foreign Application Priority Data
Apr. 20, 2010 (DE) 10 2010 015 632.9

(51) Int. Cl. C09K 5/00

(52) U.S. Cl. 252/75

(57) ABSTRACT

The invention relates to a heat transfer medium including a mixture containing elemental sulphur and at least one additive and a use of the heat transfer medium. A heat transfer medium including a mixture containing elemental sulphur and at least one additive is indicated. The heat transfer medium is characterized in that the additive includes at least one halogenated hydrocarbon. The halogenated hydrocarbon is, in particular, a chlorinated and/or brominated paraffin. The heat transfer medium is used for reversible energy storage. The heat transfer medium is preferably used for operating a solar thermal power station for converting solar energy into electric energy. Sunlight is converted into heat energy of the heat transfer medium.

### CROSS REFERENCE TO RELATED APPLICATIONS

This application is the US National Stage of International Application No. PCT/EP2011/056111, filed Apr. 18, 2011 and claims the benefit thereof. The International Application claims the benefits of German application No. 10 2010 015 632.9 DE filed Apr. 20, 2010. All of the applications are incorporated by reference herein in their entirety.

### FIELD OF INVENTION

The invention relates to a heat transfer medium comprising a mixture containing elemental sulfur and at least one additive. In addition, a use of the heat transfer medium is indicated.

### BACKGROUND OF INVENTION

Solar thermal power stations are based on the conversion of solar energy into electric energy. For this purpose, for example, in so-called parabolic trough power stations incident solar radiation is concentrated and directed at a so-called receiver tube in a solar field by means of numerous parabolic-shaped mirrors arranged in a cascade in order to heat a heat transfer fluid (heat transfer medium, “HTF”) which is circulating therein.

The thermal energy provided in this way is transformed into steam or hot gas via a heat exchange process and is converted into electric energy by means of a turbine (power block).

In principle, elemental sulfur is suitable as a heat transfer medium for such an application, as sulfur melts at approx. 119° C. and boils at 440° C. (under normal pressure). Furthermore, liquid sulfur has a relatively high heat capacity c_{P} of approx. 1.12 J/(g·K) and a relatively high thermal conductance A of approx. 0.17 W/(m·K).

However, at raised temperatures sulfur tends to form polyatomic sulfur molecules. As a result of this, sulfur has relatively high viscosity. For example, the dynamic viscosity η of sulfur at 300° C. is approx. 2,800 mPa·s. For comparison: at a temperature of 300° C. the dynamic viscosity η of common heat transfer fluids is less than 10 mPa·s or even less than 1 mPa·s.

From the publication “The Viscosity of Sulfur” by R. R. Bacon et al., Journal of the American Chemical Society, Vol. 65 (1943), p. 639 to 647 it is known how to reduce the viscosity of sulfur by means of various inorganic additives. The publication also describes how to use sulfur modified in this way as a heat transfer medium.

### SUMMARY OF INVENTION

The object of the invention is to develop a heat transfer medium based on elemental sulfur in such a way that it can be used as a heat transfer fluid.

To achieve the object a heat transfer medium comprising a mixture containing elemental sulfur and at least one additive is indicated. The heat transfer medium is characterized in that the additive comprises at least one halogenated hydrocarbon.

According to an additional aspect of the invention, a use of the heat transfer medium for reversible energy storage is indicated. The heat transfer medium absorbs energy and emits the absorbed energy again. The heat transfer medium is preferably used for operating a solar thermal power station for converting solar energy into electric energy. Sunlight is converted into heat energy of the heat transfer medium.

The idea forming the basis of the invention is to modify the sulfur with the aid of halogenated hydrocarbons.

Based on elemental sulfur, as it is extracted in the Frasch process as well as in particular in accordance with the Claus process, a system according to the invention meets important requirements for use as a heat transfer medium. As an element sulfur melts under normal pressure at approx. 119° C. and boils at 444° C. At 650° C. vapor pressure is p=10.40 bar and is therefore still easily manageable in pipework. When oxygen is excluded and at operating temperatures of 500° C.-600° C. it constitutes a non-toxic fluid.

All kinds of hydrocarbon molecules may be considered to be hydrocarbons, namely saturated, unsaturated (e.g. aromatic), cyclical, acyclical, branched and unbranched hydrocarbon molecules. The hydrocarbon may only comprise one kind of hydrocarbon molecule. Mixtures of different hydrocarbon molecules are also conceivable. All the kinds of hydrocarbon molecules used may be halogenated. However, a mixture of halogenated and non-halogenated hydrocarbon molecules may also be used.

As a result of thermal stress such molecules generate halogen radicals, which in turn inhibit sulfur radicals in their tendency to form long sulfur chains during radical chain break-off reactions. Hydrogen which can be abstracted from such a hydrocarbon reacts with sulfur to form hydrogen sulfide or saturates free S-radicals directly in the form of sulfanes. Particularly the presence of numerous molecules and/or molecular fragments acting as hydrogen suppliers has a beneficial effect on the reduction of the sulfur melt viscosity. For this reason, above all, the combination of halogenated paraffins with pure, possibly olefinic hydrocarbons, such as, for example, stearin or oleic acid or their derivatives, may be particularly effective synergistically.

At least one kind of hydrocarbon molecule is halogenated. Here at least one hydrogen atom of the halogenated hydrocarbon is replaced by one halogen atom, in other words fluorine, chlorine, bromine or iodine. Chlorine and bromine are preferably used.

A single hydrogen atom of the halogenated hydrocarbon can be replaced by one halogen atom. Several hydrogen atoms of the halogenated hydrocarbon are preferably replaced by several halogen atoms. In particular, the halogenated hydrocarbon is therefore a polyhalogenated hydrocarbon. The hydrogen atoms of the halogenated hydrocarbons can be replaced by one kind of halogen atom or by different kinds of halogen atoms.

In a polyhalogenated hydrocarbon the halogen proportion of the molecular weight of a single hydrocarbon molecule is relatively high. Preferably the halogen proportion of the molecular weight of the halogenated hydrocarbon is selected from a range of 25% to 75% by weight. A higher proportion, for example, up to 90% by weight, or a lower proportion, for example up to 10% by weight, is likewise possible.

A carbon framework of the halogenated hydrocarbon or the halogenated hydrocarbons may have any number of carbon atoms. Likewise the carbon framework of the halogenated hydrocarbon may have any length of carbon chain. An average carbon chain length of the halogenated hydrocarbon is preferably C₂ to C₃₀. The carbon chain of the halogenated hydrocarbon is produced by between two to 30 carbon atoms. More than 30 carbon atoms per carbon chain are also conceivable. Apart from that, a halogenated methane derivative with only a single carbon atom forming the framework of the halogenated hydrocarbon can also be used.

The halogenated hydrocarbon is preferably long-chain with a carbon chain length of more than C₁₀. In a particular embodiment the halogenated hydrocarbon is therefore a paraffin. The paraffin framework may be unbranched (n-paraffin) or branched (iso-paraffin). Likewise, the paraffin can be short-chain, medium-chain or long-chain. The paraffin is for example a Short-Chain Chlorinated Paraffin (SCCP, C₁₀-C₁₃), a Medium-Chain Chlorinated Paraffin (MCCP, C₁₄-C₁₇) or a Long-Chain Chlorinated Paraffin (LCCP, >C₁₈). Mixtures of the aforementioned paraffins are also conceivable.

Apart from that, the illustration with regard to the framework of the halogenated hydrocarbon also applies to any existing, non-halogenated hydrocarbons. This means, for example, that in addition to halogenated paraffins, non-halogenated paraffins can also be used.

A proportion of the additive in the mixture can be individually adjusted depending on the kind of additive or the kinds of additives. It has proved particularly advantageous if the additive is included in the mixture in a proportion selected from a range of 0.01% to 15% by weight. Higher proportions of up to 20% by weight or of up to 30% by weight are also possible.

As already mentioned, apart from halogenated hydrocarbons non-halogenated hydrocarbons are also used advantageously. Additional additives are likewise conceivable. In a particular embodiment the mixture comprises at least one additional additive selected from the group of organic polysulfide, fatty acid, metallic salt of a fatty acid, castor oil and nanoparticle.

Nanoparticles have an average particle diameter of 1 nm to 100 nm Nanoparticles can be organic or inorganic. Mixtures of organic and inorganic nanoparticles are also conceivable. For example, metals, metalloids, oxides and nitrides and sulfides or polysulfides of metals and/or metalloids and mixtures of the aforementioned compounds are used.

The castor oil is based on hydrated and/or dehydrated castor oil or derivatives thereof.

The organic polysulfide may contain saturated and unsaturated hydrocarbon fragments. According to an additional embodiment the additional additive comprises an organic polysulfide with the chemical formula R₁SₓR₂, in which x is between 2 and 8, and R₁ and R₂ are alkyl residues of the carbon chain length C₂ to C₁₈ and in particular the carbon chain length C₉ to C₁₂. Different linear and branched alkyl residues may be used. R₁ and R₂ can each also be a methyl residue or a methyl residue derivative.

According to an additional embodiment the additional additive comprises a fatty acid and/or a metallic salt of the fatty acid, wherein the fatty acid has a carbon chain length in the range of C₂ to C₂₀. Here saturated and unsaturated fatty acids or mixtures thereof are possible. Stearic acid and oleic acid and their metallic salts with alkali metals, alkaline-earth metals and transition metals are particularly suitable.

To summarize, the following advantages are associated with the invention or the invention is particularly advantageous in the following embodiments:
With the invention sulfur can be used as an inexpensive and readily available heat transfer medium.
As a result of the additive or as a result of the additives, the melt viscosity of the sulfur is reduced in the range of 120° C.-400° C. A partially through to fully halogenated derivative of an aliphatic, aromatic and/or cycloaliphatic hydrocarbon compound (unbranched and/or branched) or any mixture thereof is used.
Organic, halogenated hydrocarbon derivatives with the elements fluorine, chlorine, bromine and/or iodine are used, but preferably the elements chlorine and/or bromine.
The halogen content of the organic, halogenated hydrocarbon derivative is advantageously 25%-75% by weight of the molecular weight.
The medium carbon chain length of the organic, halogenated hydrocarbon derivative to be used in any case is C₁ to C₃₀ (so-called chlorinated and/or brominated aliphates, paraffins and waxes).
The content of the organic, halogenated hydrocarbon derivative to be used in any case is between 0.01-15% by weight of the total mass of the mixture used as a heat transfer medium.
The proportion of any additional additives is in total 0.01-15% by weight of the total mass of the mixture used as the heat transfer medium.
The heat transfer medium is used as a heat transfer fluid (HTF) in solar thermal power stations for converting solar energy into electric energy by means of specially arranged mirror systems in a solar field, e.g. by means of parabolic trough geometry.
The heat transfer medium is used as a heat reservoir (storage medium) for the purpose of reversible energy storage (so-called latent heat accumulator, thermal energy storage (TES)).
In addition, it is advantageous to use part of the solar energy obtained to provide a thermal supply to a so-called storage medium in large storage tanks in order to draw on the energy accumulated during the day from this heat reservoir during night-time operation. A continuous energy generation process can be guaranteed in this way. Ideally the property profile of the heat transfer medium also permits use as a storage medium as in this way the separate fluid circulation systems do not need to be distinguished. The heat transfer medium namely represents the critical component of this overall process in a special way and serves to transport the solar thermal energy to the heat exchanger or storage medium, as special physical, technical and market-based demands are placed on such a heat transfer medium.

The invention is described below on the basis of two exemplary embodiments.

The subject matter of the exemplary embodiments is in each case a heat transfer medium based on sulfur. In each case the heat transfer medium is a mixture with elemental sulfur as the main component. An additive in the form of a halogenated hydrocarbon is included in the mixture.

### EXAMPLE 1

Apart from sulfur, the heat transfer medium comprises an additive in the form of MCCP (polychlorinated paraffin). The halogen proportion in the MCCP is approx. 70% by weight of the molecular weight.

### EXAMPLE 2

In contrast to Example 1, LCCP is used with a halogen proportion of likewise approx. 70% by weight of the molecular weight.

1. A heat transfer medium comprising:
a mixture containing elemental sulfur and at least one additive, additive comprises at least one halogenated hydrocarbon.

2. The heat transfer medium as claimed in claim 1,
wherein the halogenated hydrocarbon being a polyhalogenated hydrocarbon.

3. The heat transfer medium as claimed in claim 1,
wherein a halogen proportion of the molecular weight of the halogenated hydrocarbon being selected from a range of 25% to 75% by weight.

4. The heat transfer medium as claimed in claim 1,
wherein an average carbon chain length of the halogenated hydrocarbons being C₂ to C₃₀.

5. The heat transfer medium as claimed in claim 1,
wherein the halogenated hydrocarbon being a paraffin.

6. The heat transfer medium as claimed in claim 1,
wherein the additive being contained with a proportion of the mixture selected from a range of 0.01% to 15% by weight.

7. The heat transfer medium as claimed in claim 1,
wherein the mixture having at least one additional additive selected from the group of organic polysulfide, fatty acid, metallic salt of a fatty acid, castor oil and nanoparticle.

8. The heat transfer medium as claimed in claim 7,
wherein the additional additive having an organic polysulfide with the chemical formula R₁SₓR₂, in which x is between 2 and 8, and R₁ and R₂ are alkyl residues of the carbon chain length C₂ to C₁₈ and in particular of the carbon chain length C₉ to C₁₂.

9. The heat transfer medium as claimed in claim 7,
wherein the additional additive comprising a fatty acid and/or a metallic salt of the fatty acid and the fatty acid comprising a carbon chain length in a range of C₂ to C₂₀.

10. The use of a heat transfer medium as claimed in claim 1 for reversible energy storage.

11. The use as claimed in claim 10 for operating a solar thermal power station for transforming solar energy into electric energy, sunlight being converted into heat energy of the heat transfer medium.

12. The heat transfer medium as claimed in claim 2,
wherein a halogen proportion of the molecular weight of the halogenated hydrocarbon being selected from a range of 25% to 75% by weight.

13. The heat transfer medium as claimed in claim 2,
wherein an average carbon chain length of the halogenated hydrocarbons being C₂ to C₃₀.

14. The heat transfer medium as claimed in claim 3,
wherein an average carbon chain length of the halogenated hydrocarbons being C₂ to C₃₀.

15. The heat transfer medium as claimed in claim 2,
wherein the halogenated hydrocarbon being a paraffin.

16. The heat transfer medium as claimed in claim 3,
wherein the halogenated hydrocarbon being a paraffin.

17. The heat transfer medium as claimed in claim 4,
wherein the halogenated hydrocarbon being a paraffin.

18. The heat transfer medium as claimed in claim 2,
wherein the mixture having at least one additional additive selected from the group of organic polysulfide, fatty acid, metallic salt of a fatty acid, castor oil and nanoparticle.

19. The heat transfer medium as claimed in claim 3,
wherein the mixture having at least one additional additive selected from the group of organic polysulfide, fatty acid, metallic salt of a fatty acid, castor oil and nanoparticle.

20. The heat transfer medium as claimed in claim 4,
wherein the mixture having at least one additional additive selected from the group of organic polysulfide, fatty acid, metallic salt of a fatty acid, castor oil and nanoparticle.
